(19) United States
(12) Patent Application Publication
(10) Pub. No.: US 2005/0035161 A1
(43) Pub. Date: Feb. 17, 2005

(54) Fastener for a golf ball cleaning device

(76) Inventor: Yoshihiko Shioda, Charlotte, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(21) Appl. No.: 10/639,941

(22) Filed: Aug. 13, 2003

(51) Int. Cl. A63B 47/04; A45F 5/02; B65D 25/52; A01K 97/04; A01K 97/06; A47L 1/06; A47K 7/02; A47L 13/10; A47L 23/04

(52) U.S. Cl. 224/194; 15/209.1; 15/210.1; 224/197

(57) ABSTRACT

A fastener for fastening a golf ball cleaning device to clothing wherein the fastener has a base portion secured to the back surface of the golf ball cleaning device and a pair of resilient spaced retaining legs extending from the base portion parallel with and spaced from the back surface of the golf ball cleaning device. The legs form a slot for insertion and retention therein of a button having an extent of clothing thereover.

### BACKGROUND OF THE INVENTION

The present invention relates generally to a fastener for a golf ball cleaning device for use by a golfer to attach a golf ball cleaning device to a golfer's clothing.

In playing golf, often a golfer must clean his golf ball of dirt, grass and other debris so that it will not be adversely affected when stroked. This is particularly significant in putting. Usually mechanical ball washers are available only adjacent teeing areas and are not available on the fairways or around the putting greens when a golfer often needs to clean his ball. Therefore, it is desirable for a golfer to be able to carry and wear his or her own personal golf ball cleaner, which should not interfere with his or her swing or play. Thus, there is a need for a means such as a fastener to easily and without damage attach a golf ball cleaning device to the golfer. It is accordingly an object of the present invention to provide such a fastener.

### SUMMARY OF THE INVENTION

Basically, the fastener for fastening a golf ball cleaning device to clothing according to the present invention is formed on the back surface of the golf ball cleaning device that has a front ball cleaning surface. It has a button retaining member having a base portion secured to and projecting from the back surface of the golf ball cleaning device and from which a pair of resilient spaced retaining legs extend generally parallel with and at a spacing from the back surface of the golf ball cleaning device to form a button receiving slot therebetween. A cloth retaining button having a base, a narrow intermediate portion and an enlarged head spaced from the button base by the intermediate portion is receivable into the slot with an extent of clothing over the head of the button. The legs have outer portions spaced apart less than the thickness of the button intermediate portion with an extent of clothing thereover, whereby insertion into the slot of the button intermediate portion with an extent of clothing over the head and intermediate portion causes the resilient legs to spread to accommodate insertion of the button and cloth extent. The legs have interior portions spaced apart greater than the outer portions, whereby the outer portions resiliently retain the inserted button and cloth extent between the interior portions, thereby attaching the golf ball cleaning device to the clothing of the golfer.

In the preferred embodiment of the present invention, the fastener legs have laterally outward spacer portions projecting towards the back surface of the golf ball cleaning device for engaging the back surface of the golf ball cleaning device to space laterally inward portions of the legs from the back surface of the golf ball cleaning device to accommodate insertion of the button base and cloth extent under the laterally inward portions of the legs. The outer ends of the legs are flared laterally outwardly to accommodate insertion of the button into the slot. The legs are formed with opposed inwardly projecting portions inwardly of the interior portions to provide a stop for the inserted button, and the legs have narrow portions adjacent the base portion to facilitate flexing of the resilient legs to accommodate spreading of the legs to allow insertion of the button intermediate portion with the cloth extent thereover. The interior portions of the legs form a circular portion in the slot and the intermediate portion of the button is circular in cross-section for retention in the circular portion of the slot. Preferably, a line is attached to the button for independent retention of the button when unattached to the legs, and a knob is attached to an outer end of the line to facilitate handling of the line.

A preferred golf ball cleaning device for use with the fastener of the present invention is disclosed in U.S. Pat. No. 6,148,464 and U.S. Pat. No. 6,550,093, herein incorporated by reference.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a fastener for a golf ball cleaning device according to the preferred embodiment of the present invention;

FIG. 2 is a front view of the fastener of FIG. 1;

FIG. 3 is a side view of the fastener of FIG. 1;

FIG. 4 is an end view of the fastener of FIG. 1;

FIG. 5 is a sectional view taken along line 5-5 in FIG. 2;

FIG. 6 is a sectional view taken along line 6-6 in FIG. 2;

FIG. 7 is a sectional view taken along line 7-7 in FIG. 2;

FIG. 8 is a perspective view of the button of the preferred embodiment that is inserted with the fabric of a golfer's shirt or pants into the fastener of FIG. 1;

FIG. 9 is a front view of the circular button of FIG. 1;

FIG. 10 is a sectional view taken along line 10-10 in FIG. 9;

FIG. 11 is a perspective view of the button of the preferred embodiment of the present invention under a golfer's clothing;

FIG. 12 is a perspective view of the button of the fastener of FIG. 1 with an extent of golfer's clothing in position prior to placing over the button;

FIG. 13 is a perspective view of the fastener of FIG. 1 with the button and clothing in position prior to insertion;

FIG. 14 is a perspective view of the fastener of FIG. 1 prior to insertion of the button and clothing therein;

FIG. 15 is a front view of the button and extent of clothing partially inserted between the legs of the fastener in FIG. 1;

FIG. 16 is a view similar to FIG. 15 showing the button and extent of clothing fully inserted in the fastener of FIG. 1;

FIG. 17 is a perspective view of the fastener of FIG. 1 affixing a golf ball cleaning device to he pants of a golfer; and

FIG. 18 is a sectional view of the button and extent of clothing inserted between the legs of the fastener in FIG. 1.

### DETAILED DESCRIPTION OF THE PREFERRED EMBODIMENT

The present invention will now be described fully hereinafter with reference to the accompanying drawings, in which the preferred embodiment of the present invention is shown. This invention may, however, be embodied in many different forms and should not be considered as limited to the embodiment set forth herein. Rather this embodiment is provided so that this disclosure will be thorough and complete, and will fully convey the scope of the invention to those skilled in the art. It will be understood that all alternatives, modifications, and equivalents are intended to be included within the spirit and scope of the invention as defined by the appended claims.

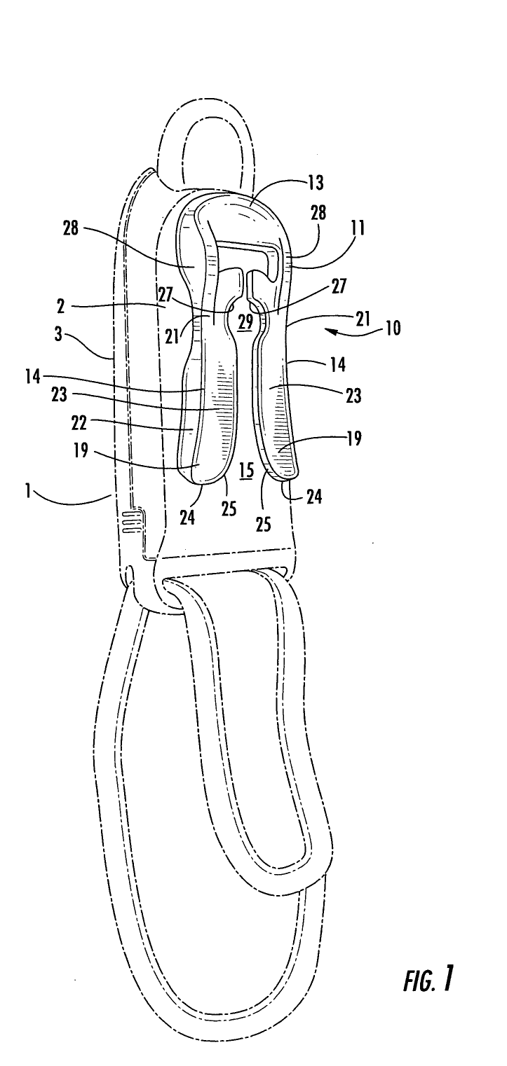

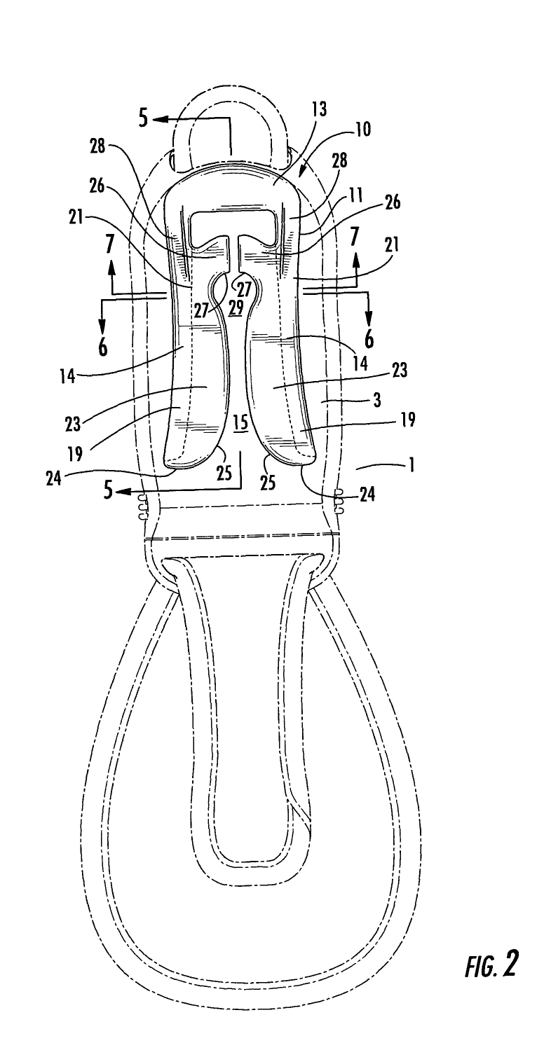

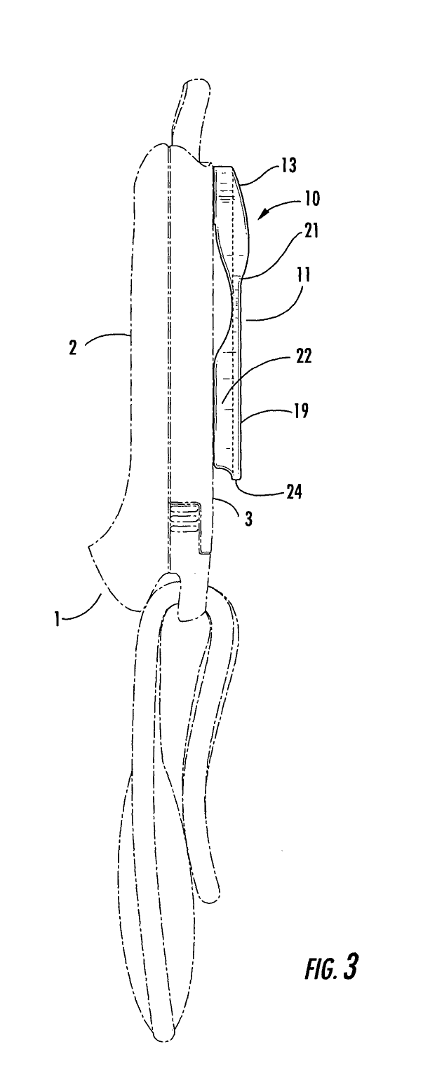

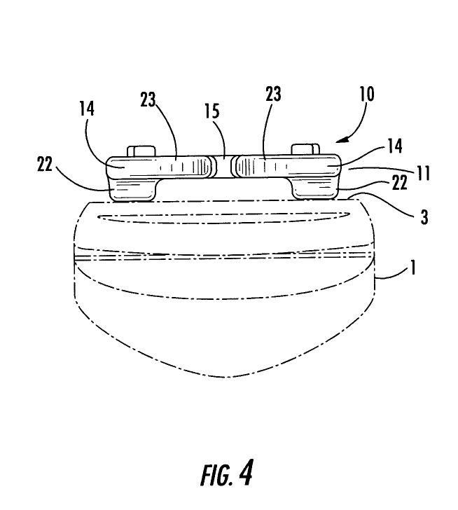

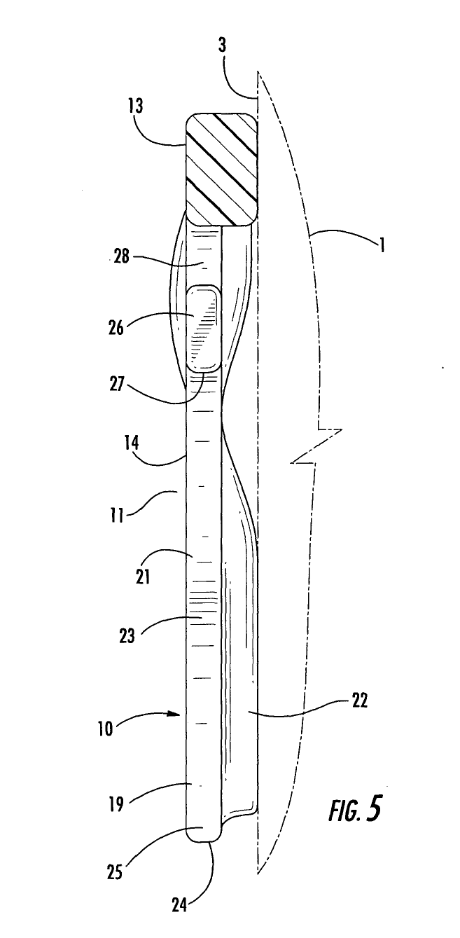

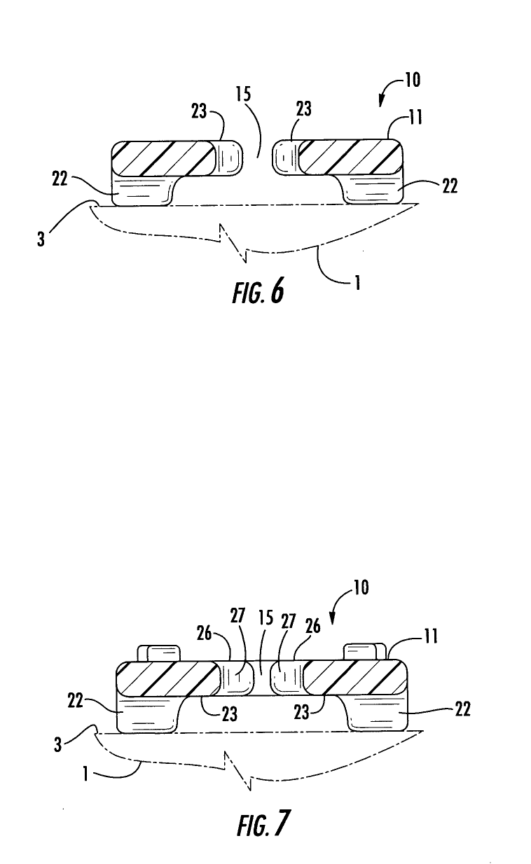

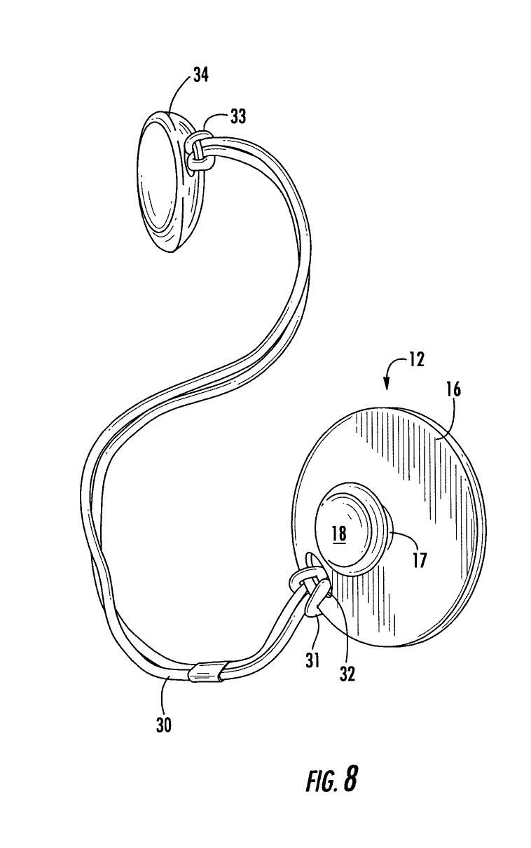

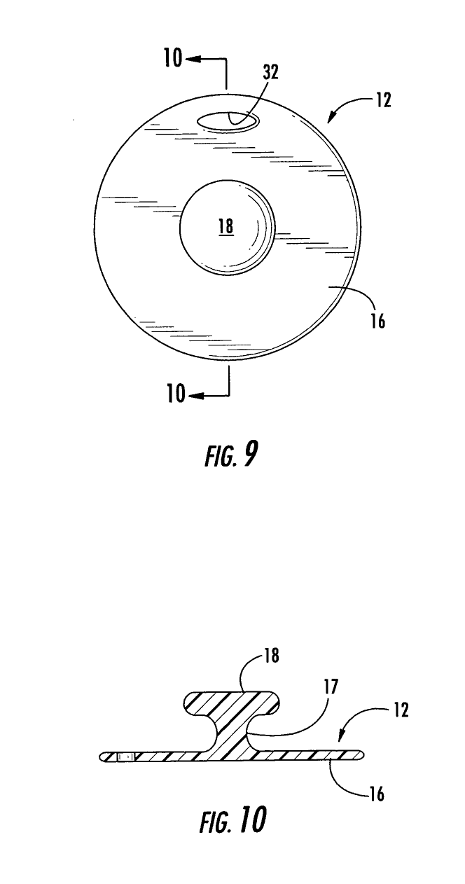

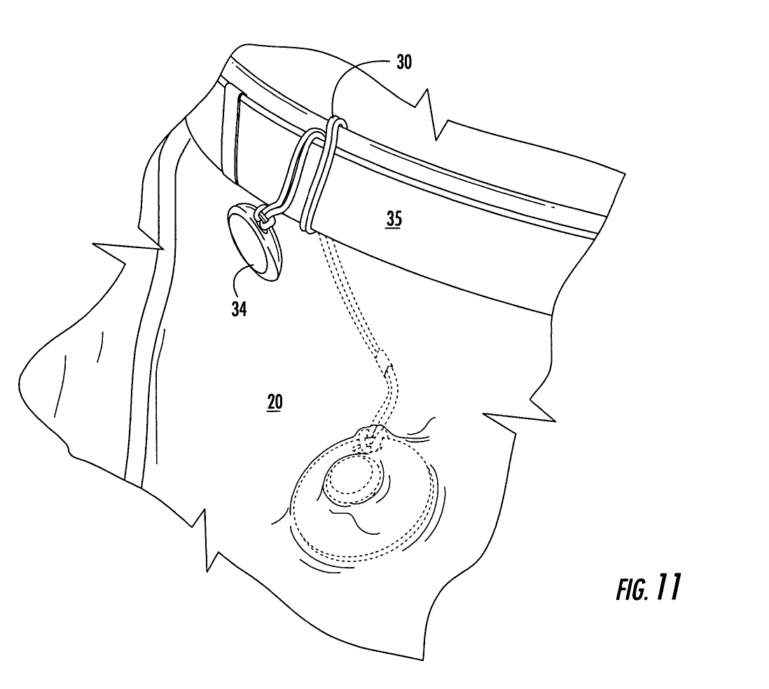

The fastener of the present invention may be attached to a golf ball cleaning device outlined in dot-dash lines as seen in FIG. 1. The golf ball cleaning device 1 has a back surface 2 and a front ball cleaning surface 3. The golf ball cleaning device can take various forms. However, preferred golf ball cleaning devices for use with the fastener of the present invention are disclosed in U.S. Pat. No. 6,148,464 and U.S. Pat. No. 6,550,093, herein incorporated by reference.

The fastener 10 of the preferred embodiment of the present invention includes a button retaining member 11 and a button 12 that is removably retained in the button retaining member 11. The button retaining member 11 has a base portion 12 secured to and projecting from the back surface 2 of the ball cleaning device 1. A pair of resilient spaced retaining legs 14 extend from the base portion 12 generally parallel with and at a spacing from the back surface 2 of the ball cleaning device 1 to form a button receiving slot 15 therebetween.

The button 12 has a round base portion 16 that is of a thickness less than the spacing of the legs 14 from the back surface 2 of the ball cleaning device 1. The base 16 of the button 12 is circular and larger in diameter than the width of the slot 15 so that it retains the button 12 in the slot 15 when the button is inserted in the slot. The button 12 has an intermediate portion 17 projecting from the button base 16 and being cylindrical in cross-section with a diameter that allows forced insertion into the slot 15. The button has an enlarged head 18 formed at the end of the intermediate portion 17. The head 18 is circular and larger in diameter than the width of the slot 15.

The resilient legs 14 have outer portions 19 spaced apart less than the thickness of the button intermediate portion 17 when an extent of clothing 20 is placed over the button head 18 and intermediate portion 17. Thus, when the button intermediate portion 17 with the extent of clothing 20 over the head and intermediate portion is inserted into the slot 15 it will force the resilient legs 14 to spread to accommodate the insertion.

The legs 14 have interior portions 21 spaced apart a greater distance than the outer portions 19 of the legs 14 so that the legs resiliently retain the inserted button 12 and the cloth extent 20 between the interior portions 21.

The legs 14 have laterally outward spacer portions 22 projecting toward the back surface 2 of the golf ball cleaning device 1 for engaging the back surface 2 of the golf ball cleaning device 1 to space laterally inward portions 23 of the legs 14 from the back surface 2 of the golf ball cleaning device 1. The laterally outward spacer portions 22 extend toward the back surface 2 of the golf ball cleaning device 1 a distance greater than the height of the button base 16 with the cloth extent 20 thereover so that the laterally inward portions 23 of the legs 14 are spaced from the back surface 2 of the golf ball cleaning device 1 a distance sufficient to allow insertion of the button base 16 and cloth extent 20 under the laterally inward portions 23 of the legs 14, and the laterally outward spacer portions 22 are spaced apart greater than the diameter of the button base 16 to permit insertion of the button base 16 therebetween.

The legs 14 have outer ends 24 that are flared laterally outwardly, as indicated by the reference numeral 24, to accommodate insertion of the button intermediate portion 17 into the slot 15. The legs 14 are also formed with opposed inwardly projecting portions 26 inwardly of the interior portions 21 thereof to provide a stop 27 limiting the insertion of the button 12 in the slot 15. The spaced apart interior portions 21 of the legs 14 form a circular portion 29 in the slot 15 interiorally of the spaced apart outer portions 19 for snuggly retaining the intermediate portion 17 of the button 12 with the cloth extent 20 thereover within the circular portion 29 of the slot 15.

The legs 14 are formed with narrow portions 28 between the base 13 and the stop 27 to facilitate flexing of the resilient legs 14 to accommodate spreading of the legs to allow insertion of the button intermediate portion 17 with the cloth extent 20 thereover through the slot 15 into the circular portion 29 of the slot 15.

A line 30 has an end 31 secured in a hole 32 in the button base 16. The other end 33 of the line 30 is tied to a knob 34 to facilitate handling of the line 30, which line 30 serves to independently retain the button 12 when it is not attached to the button retaining member 11.

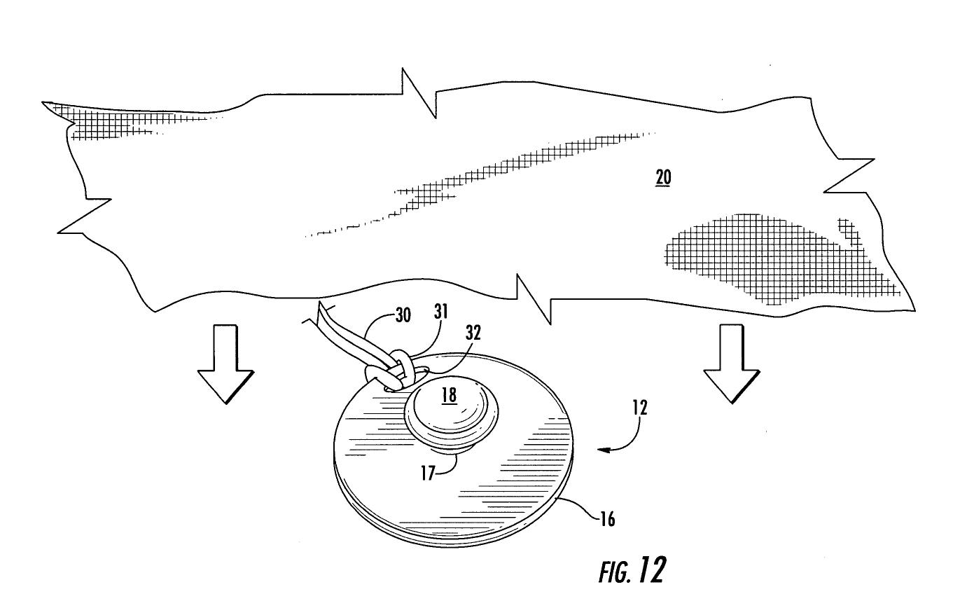

In use to attach the golf ball cleaning device 1 to an article of clothing of a golfer, such as to a shirt or pants or skirt, the button 12 is first connected to the clothing of the golfer by wrapping the line 30 around a belt 35 (FIG. 11) worn by the golfer or placing the knob 34 in a pocket or otherwise attaching it to the clothing. If preferred, the user can detach the line 30 from the button 12 and not use it.

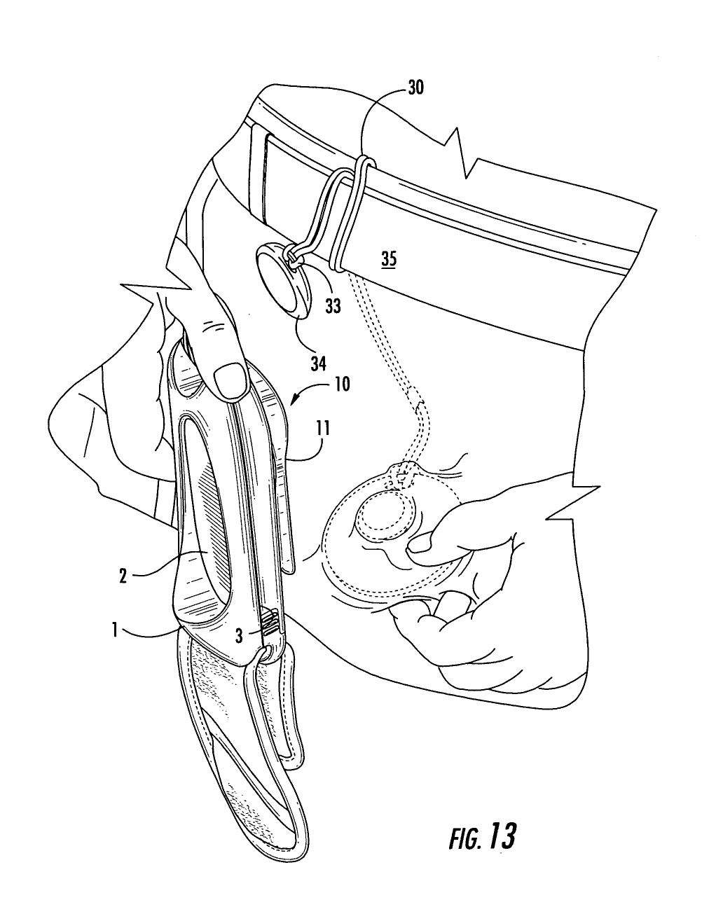

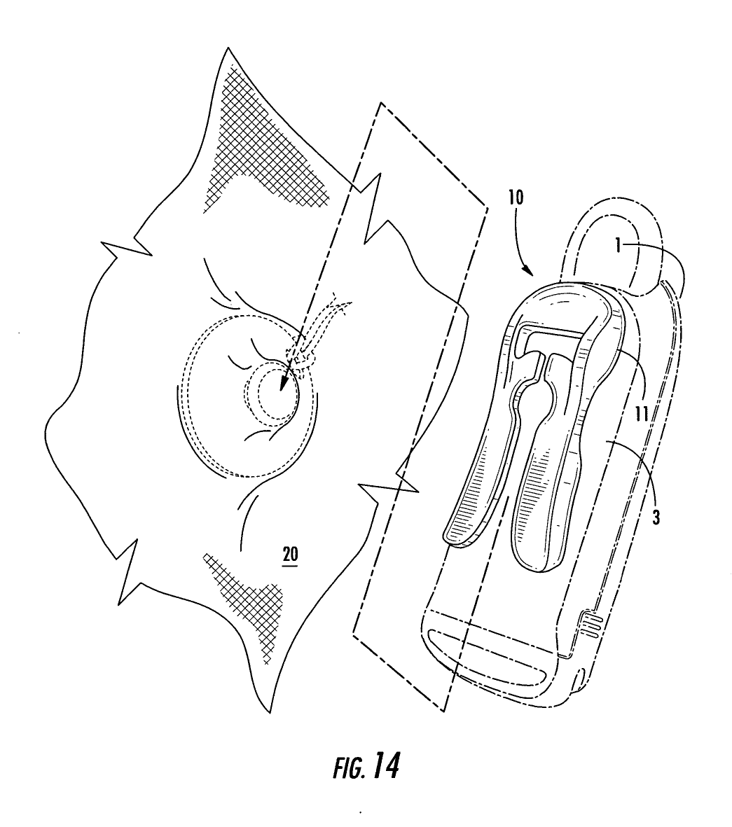

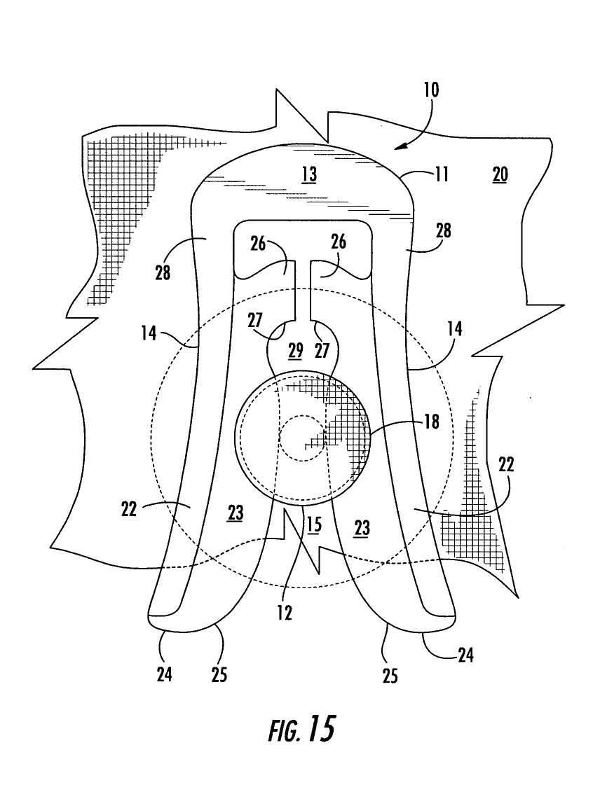

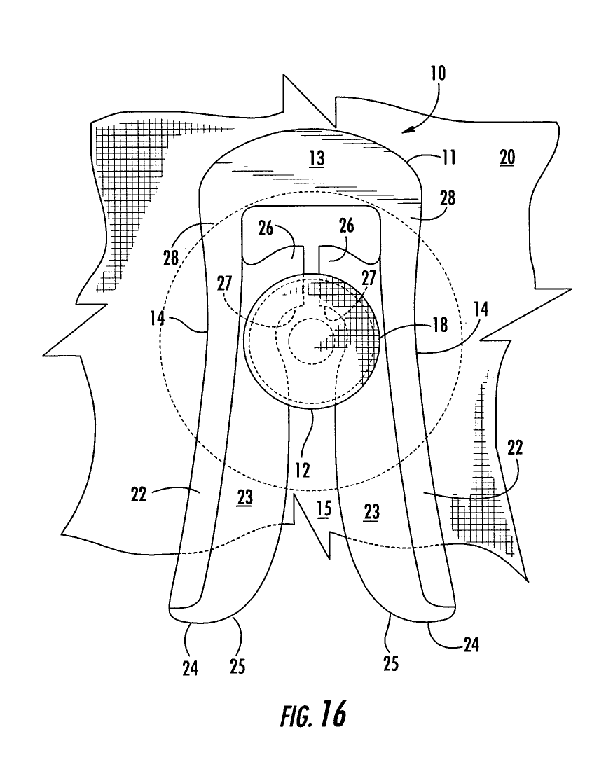

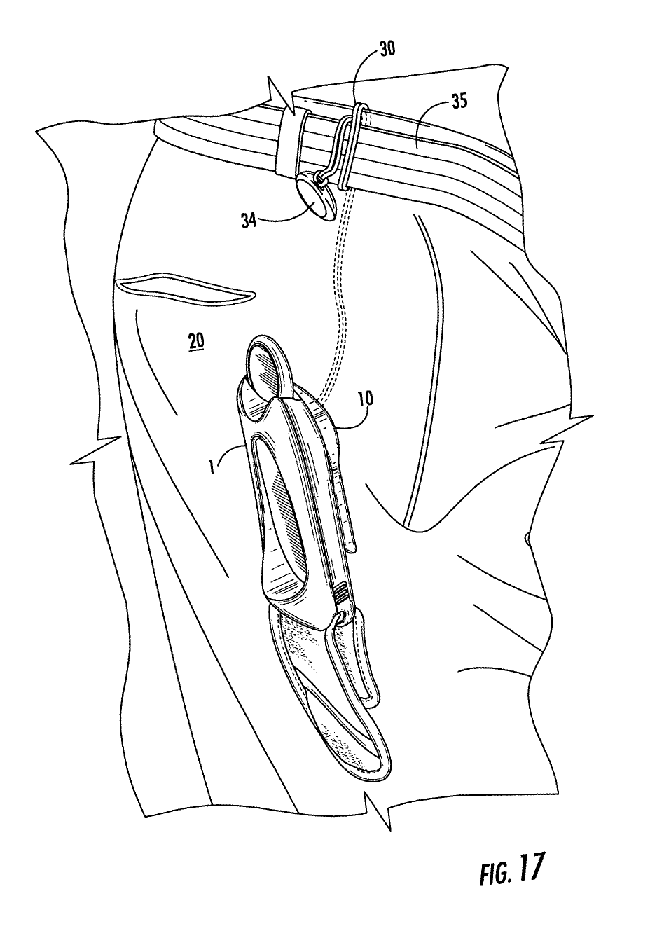

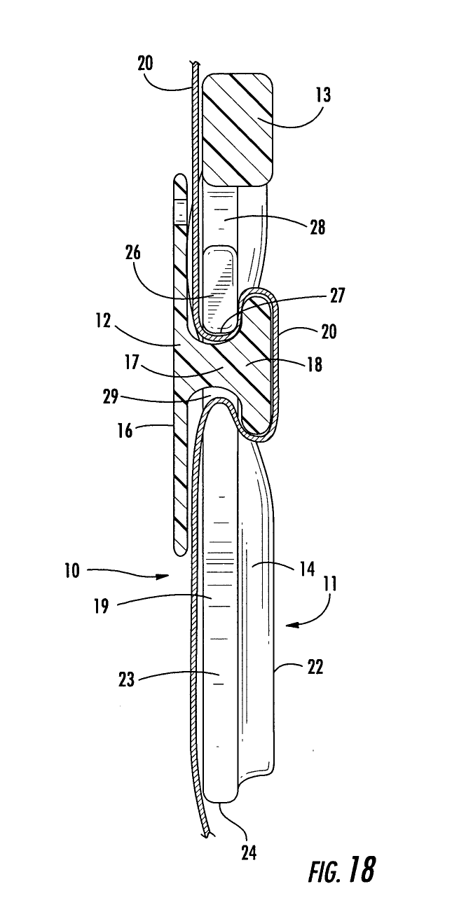

The button 12 is then placed under a cloth extent 20 of the clothing at a location where it is desired to attached the golf ball cleaning device 1 (FIG. 12). The button retaining member 11 is then grasped (FIG. 13) and placed with the legs 14 adjacent to the button 12 with the cloth thereover (FIG. 14). The legs 14 are then forced over the intermediate portion 17 of the button 12 with the button being thereby inserted into the slot 15. The flare 25 of the outer ends 24 facilitate this insertion. During insertion, the intermediate portion 17 of the button 12 forces the legs 14 to flex resiliently apart (FIG. 15) until the intermediate portion 17 of the button 12 with the cloth extent 20 thereover is received in the circular portion 29 of the slot 15 and retained against the stop 27 (FIG. 16) at which time the legs 14 flex back to their original position to retain the button 12 in the circular portion 29. The golf ball cleaning device 1 is thus conveniently detachably attached to the clothing of the golfer (FIG. 17) for ready availability for cleaning a golf ball.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A fastener for fastening a golf ball cleaning device to clothing, the golf ball cleaning device having a front ball cleaning surface and a back surface, said fastener comprising:
a cloth retaining button having a base, a narrow intermediate portion and an enlarged head spaced from said button base by said intermediate portion,
a button retaining member having a base portion secured to and projecting from the back surface of said golf ball cleaning device, and a pair of resilient spaced retaining legs extending from said base portion generally parallel with and at a spacing from the back surface of the golf ball cleaning device to form a button receiving slot therebetween,
said legs having outer portions spaced apart less than the thickness of said button intermediate portion with an extent of clothing thereover, whereby insertion into said slot of said button intermediate portion with an extent of clothing over said head and intermediate portion causes said resilient legs to spread to accommodate insertion of said button and cloth extent,
said legs having interior portions spaced apart greater than said outer portions, whereby said outer portions resiliently retain said inserted button and cloth extent between said interior portions.

2. The fastener according to claim 1 and characterized further in that said legs have laterally outward spacer portions projecting toward the back surface of the golf ball cleaning device for engaging the back surface of the golf ball cleaning device to space laterally inward portions of said legs from said back surface of said golf ball cleaning device to accommodate insertion of said button base and cloth extent under said legs.

3. The fastener according to claim 1 and characterized further in that the outer ends of said legs are flared laterally outwardly to accommodate insertion of said button intermediate portion into the slot.

4. The fastener according to claim 1 and characterized further in that said legs are formed with opposed inwardly projecting portions inwardly of said interior portions to provide a stop for said button.

5. The fastener according to claim 1 and characterized further in that said legs each have narrow portions adjacent said base portion to facilitate flexing of said resilient legs to accommodate spreading of said legs to allow insertion of said button intermediate portion with the cloth extent thereover.

6. The fastener according to claim 4 and characterized further in that said legs are formed with narrow portions adjacent said base portion inwardly of said stop to facilitate flexing of said resilient legs to accommodate spreading of said legs to allow insertion of said button intermediate portion with the cloth extent thereover.

7. The fastener according to claim 1 and characterized further in that said spaced apart interior portions of said legs form a circular portion in said slot interiorly of said spaced apart outer portions of said legs, and said intermediate portion of said button is circular in cross-section for retention in said circular portion of said slot.

8. The fastener according to claim 1 and characterized further by a line attached to said button for independent retention of said button when not attached to said button retaining member.

9. The fastener according to claim 8 and characterized further by a knob attached to an outer end of said line to facilitate handling of said line.

10. A fastener for fastening a device to cloth, said fastener comprising:
a cloth retaining button having a base, a narrow intermediate portion and an enlarged head spaced from said button base by said intermediate portion,
a button retaining member having a base portion secured to and projecting from the device, and a pair of resilient spaced retaining legs extending from said base portion at a spacing from the device to form a button receiving slot therebetween,
said legs having outer portions spaced apart less than the thickness of said button intermediate portion with an extent of cloth thereover, whereby insertion into said slot of said button intermediate portion with an extent of cloth over said head and intermediate portion causes said resilient legs to spread to accommodate insertion of said button and cloth extent,
said legs having interior portions spaced apart greater than said outer portions, whereby said outer portions resiliently retain said inserted button and cloth extent between said interior portions.

11. The fastener according to claim 10 and characterized further in that said legs have laterally outward spacer portions projecting toward the device for engaging the device to space laterally inward portions of said legs from the device to accommodate insertion of said button base and cloth extent under said legs.

12. The fastener according to claim 10 and characterized further in that the outer ends of said legs are flared laterally outwardly to accommodate insertion of said button intermediate portion into the slot.

13. The fastener according to claim 10 and characterized further in that said legs are formed with opposed inwardly projecting portions inwardly of said interior portions to provide a stop for said button.

14. The fastener according to claim 10 and characterized further in that said legs each have narrow portions adjacent said base portion to facilitate flexing of said resilient legs to accommodate spreading of said legs to allow insertion of said button intermediate portion with the cloth extent thereover.

15. The fastener according to claim 13 and characterized further in that said legs are formed with narrow portions adjacent said base portion inwardly of said stop to facilitate flexing of said resilient legs to accommodate spreading of said legs to allow insertion of said button intermediate portion with the cloth extent thereover.

16. The fastener according to claim 10 and characterized further in that said spaced apart interior portions of said legs form a circular portion in said slot interiorly of said spaced apart outer portions of said legs, and said intermediate portion of said button is circular in cross-section for retention in said circular portion of said slot.

17. The fastener according to claim 10 and characterized further by a line attached to said button for independent retention of said button when not attached to said button retaining member.

18. The fastener according to claim 17 and characterized further by a knob attached to an outer end of said line to facilitate handling of said line.
